(19) United States
(12) Patent Application Publication
(10) Pub. No.: US 2021/0197435 A1
(43) Pub. Date: Jul. 1, 2021

(54) SHOOTING POT ASSEMBLY

(71) Applicant: Niigon Machines Ltd., Vaughan (CA)

(72) Inventors: Carsten Link, Burlington (CA); Roberto Sicilia, Mississauga (CA); Luke Osmokrovic, Toronto (CA); Ivan V. Nikolaev, Richmond Hill (CA)

(73) Assignee: Niigon Machines Ltd., Vaughan (CA)

(21) Appl. No.: 17/201,683

(22) Filed: Mar. 15, 2021

Related U.S. Application Data
(63) Continuation of application No. PCT/CA2019/051339, filed on Sep. 20, 2019.
(60) Provisional application No. 62/733,975, filed on Sep. 20, 2018.

(51) Int. Cl. B29C 45/53; B29C 45/58

(52) U.S. Cl. CPC B29C 45/535; B29C 45/586

(57) ABSTRACT

A shooting pot assembly for a two-stage injection unit includes: (a) a housing; (b) a plunger chamber in the housing; (c) an injection plunger in the plunger chamber; and (d) a conduit network including (i) a feed conduit, (ii) an outlet conduit, and (iii) a transfer conduit. The shooting pot assembly further includes (e) a purge valve assembly having a purge conduit open to the plunger chamber and in fluid communication with the transfer conduit via the plunger chamber when the plunger is in the advanced position. The purge valve assembly further includes a purge valve closure member movable between a closed position, in which the purge conduit is blocked, and an open position, in which the purge conduit is open for flushing stale melt from the transfer conduit through the purge conduit via supply of fresh melt into the transfer conduit from the feed conduit.

This application is a continuation of International Patent Application Serial No. PCT/CA2019/051339, filed Sep. 20, 2019, which claims the benefit of Provisional Application Ser. No. 62/733,975, filed Sep. 20, 2018, each of which is hereby incorporated herein by reference.

### FIELD

The specification relates generally to injection molding, and more specifically, to a shooting pot assembly for a two-stage injection unit.

### BACKGROUND

U.S. Pat. No. 5,380,187 (Sodick) purports to disclose a pre-plasticization type injection molding machine equipped with a plasticizing part for plasticizing synthetic resin material by turning a screw in a heating cylinder and an injection part for injecting the plasticized material through a nozzle by advancing and retreating an injection plunger into and from an injection cylinder. A conduit connects the tip of a plasticizing chamber, consisting of the heating cylinder, with the tip of an injection chamber consisting of the injection cylinder. The screw advances at the time of injection, closes the conduit with its tip. The opening of the conduit in the injection chamber is arranged on the periphery of a nozzle side-wall. An injection passage extends from the injection chamber toward the nozzle, the passage being open to the center of the nozzle side-wall. An injection by-pass extends from the injection chamber toward the injection passage, the injection by-pass being open on the nozzle side-wall to a region opposite to the conduit opening with the injection passage therebetween. As the injection plunger advances, dissolved material in the injection chamber is introduced in to the nozzle through the injection passage while material is retained after the previous injection is introduced in to the nozzle by way of the injection by-pass.

U.S. Pat. No. 6,527,539 (Husky Injection Molding Systems) purports to disclose an injection unit (10) of an injection system, including a shooting pot (12) having a shooting pot head (13) at one end, defining a melt chamber (14) therein. The injection unit further includes a melt inlet channel (16) for laterally bringing melt into the melt chamber (14). A plunger (26) is arranged in the melt chamber (14), the plunger (26) being linearly moveable from a retracted position into an extended position, so as to force melt accumulated in the melt chamber (14) through a melt outlet channel (20) arranged in said shooting pot head (13) into an injection mold. An annular melt passage (28) is provided between the melt chamber (14) and the plunger (26), for allowing the melt to flow from the melt inlet channel (16) to an outlet end (18) of the melt chamber (14). A melt distribution channel (30) is provided for distributing the melt from the melt inlet channel (16) to the annular melt passage (28), and importantly, the melt distribution channel (30) is distal from the melt inlet channel (16) so as to ensure even distribution of the melt to the annular melt passage (28).

U.S. Pat. No. 6,649,094 (Husky Injection Molding Systems) purports to disclose methods for enhanced purging of an injection molding shooting pot assembly. Old melt is purged from a shooting pot having an injection plunger slidably received in an injection cylinder. The plunger is moved by a powered piston, which moves the injection plunger to a purging position. The plunger is then arrested in the purging position. Sufficient new melt is injected through an inlet positioned such that the new melt sweeps substantially an entire volume of the injection cylinder ahead of the injection plunger in flowing between the inlet and a single outlet remote from the inlet.

### SUMMARY

The following summary is intended to introduce the reader to various aspects of the applicant's teaching, but not to define any invention.

According to some aspects, a shooting pot assembly for a two-stage injection unit includes: (a) a housing having a nozzle at a front end of the housing for engagement with a mold sprue bushing; (b) a plunger chamber in the housing axially rearward of the nozzle, the plunger chamber extending along a chamber axis; (c) an injection plunger in the plunger chamber, the injection plunger translatable along the chamber axis between advanced and retracted positions; and (d) a conduit network in the housing. The conduit network includes (i) a feed conduit for receiving melt from a plasticizing barrel, (ii) an outlet conduit for conducting melt to the nozzle, and (iii) a transfer conduit open to the plunger chamber. The transfer conduit selectively provides fluid communication between the feed conduit and the plunger chamber to conduct melt from the plasticizing barrel to the plunger chamber, and between the plunger chamber and the outlet conduit to conduct melt from the plunger chamber to the nozzle. The shooting pot assembly further includes (e) a purge valve assembly in the housing. The purge valve assembly includes a purge conduit extending between an inlet and an outlet opposite the inlet. The inlet is open to the plunger chamber and in fluid communication with the transfer conduit through the plunger chamber when the plunger is in the advanced position. The purge valve assembly further includes a purge valve closure member in the purge conduit. The purge valve closure member is movable between a closed position and an open position. When the purge valve closure member is in the closed position, the purge conduit is blocked to inhibit evacuation of melt from the plunger chamber through the purge conduit. When the purge valve closure member is in the open position, the purge conduit is open for flushing stale melt from the transfer conduit through the purge conduit via supply of fresh melt into the transfer conduit from the feed conduit.

In some examples, the housing includes a transition head at a front of the plunger chamber. The transition head has an inner transition head surface directed toward the plunger and the plunger has a complementary leading surface directed toward the transition head surface. When the plunger is in the advanced position, the leading surface of the plunger is proximate the transition head surface and at least one flow channel is provided between the transition head surface and the leading surface of the plunger. The transition conduit is in fluid communication with the inlet of the purge conduit via the at least one flow channel.

In some examples, when the plunger is in the advanced position the leading surface of the plunger is spaced apart from the transition head surface by a gap, and the at least one flow channel comprises the gap.

In some examples, the leading surface of the plunger comprises an engagement portion, the engagement portion abutting a portion of the transition head surface when the plunger is in the advanced position.

In some examples, the at least one flow channel comprises a first chamber groove in the inner surface of the plunger chamber, the first chamber groove comprising a first groove surface spaced apart from the leading surface

In some examples, the at least one flow channel includes a circumferential plunger groove in a radially outer surface of the plunger and disposed axially rearward of the leading surface. The plunger groove and the inlet of the purge conduit are in fluid communication when the plunger is in the advanced position. In some examples, the at least one flow channel further includes a first chamber groove in the transition head surface. The first chamber groove is radially opposite of the inlet of the purge conduit, and when the plunger is in the advanced position, the first chamber groove extends between the transfer conduit and the plunger groove for providing fluid communication therebetween.

In some examples, the at least one flow channel includes a second chamber groove in the transition head surface. The second chamber groove extends between the transfer conduit and the inlet of the purge conduit for providing fluid communication therebetween when the plunger is in the advanced position.

In some examples, the leading surface of the plunger includes an engagement portion. The engagement portion abuts a portion of the transition head surface when the plunger is in the advanced position.

In some examples, when the plunger is in the advanced position the leading surface of the plunger is spaced apart from the transition head surface by a gap, and the at least one flow channel comprises the gap.

In some examples, the shooting pot assembly further includes a transfer valve assembly in the conduit network between the feed conduit, the outlet conduit, and the transfer conduit. The transfer valve assembly includes a transfer valve closure member movable between a feed position in which the transfer conduit is in fluid isolation of the outlet conduit and in fluid communication with the feed conduit for conducting melt from the plasticizing barrel to the plunger chamber, and an injection position in which the transfer conduit is in fluid isolation of the feed conduit and in fluid communication with the outlet conduit for conducting melt from the plunger chamber to the nozzle.

In some examples, the shooting pot assembly further includes an actuator for moving the purge valve closure member from the closed position to the open position.

According to some aspects, a shooting pot assembly for a two-stage injection unit includes: (a) a housing; (b) a plunger chamber in the housing; (c) an injection plunger in the plunger chamber; and (d) a conduit network including (i) a feed conduit, (ii) an outlet conduit, and (iii) a transfer conduit. The shooting pot assembly further includes (e) a purge valve assembly having a purge conduit open to the plunger chamber and in fluid communication with the transfer conduit via the plunger chamber when the plunger is in the advanced position. The purge valve assembly further includes a purge valve closure member movable between a closed position, in which the purge conduit is blocked, and an open position, in which the purge conduit is open for flushing stale melt from the transfer conduit through the purge conduit via supply of fresh melt into the transfer conduit from the feed conduit.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic elevation view of an example injection molding machine;

FIG. 2 is a schematic cross-sectional view of a portion of an injection unit of the machine of FIG. 1, showing a transfer valve of the injection unit in a feed configuration;

FIG. 2A is an enlarged view of a portion of FIG. 2, but showing the transfer valve in an injection configuration;

FIG. 3A is a partial cross-sectional view of a portion of a shooting pot assembly of the injection unit of FIG. 2, showing a purge valve of the shooting pot assembly in a closed configuration;

FIG. 3B is a partial cross-sectional view like that of FIG. 3A, but showing the purge valve in an open configuration;

FIG. 4 is a perspective view of a transition head of the injection unit of FIG. 2;

FIG. 5 is schematic cross-sectional view of a portion of another shooting pot assembly for an injection molding machine like that of FIG. 1, showing a purge valve of the shooting pot assembly in a closed configuration;

FIG. 6 is an enlarged view of a portion of FIG. 5; and

FIG. 7 is a schematic cross-sectional view of a portion of another shooting pot assembly for an injection molding machine like that of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

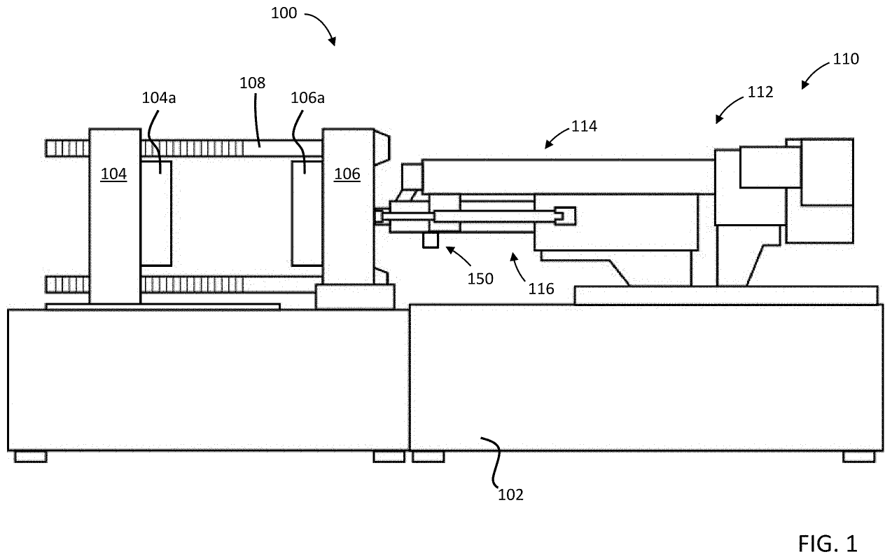

Referring to FIG. 1, an example injection molding machine 100 includes a base 102, with a moving platen 104 and a stationary platen 106 mounted to the base 102 and coupled together via tie bars 108. A mold is formed between the platens 104, 106, the mold defined at least in part by a first mold half 104a mounted to the moving platen 104, and a second mold half 106a mounted to the stationary platen 106.

A two-stage injection unit 110 is mounted to the base 102 for plasticizing and injecting resin or other mold material into the mold to form a molded article. The injection unit 110 includes a plasticizing apparatus 112 having a plasticizing barrel 114. The plasticizing apparatus 112 can plasticize resin (also referred to as melt) in the plasticizing barrel 114. In the example illustrated, the injection unit 110 further includes a shooting pot assembly 116 for receiving melt from the plasticizing barrel 114, and injecting the melt into the mold.

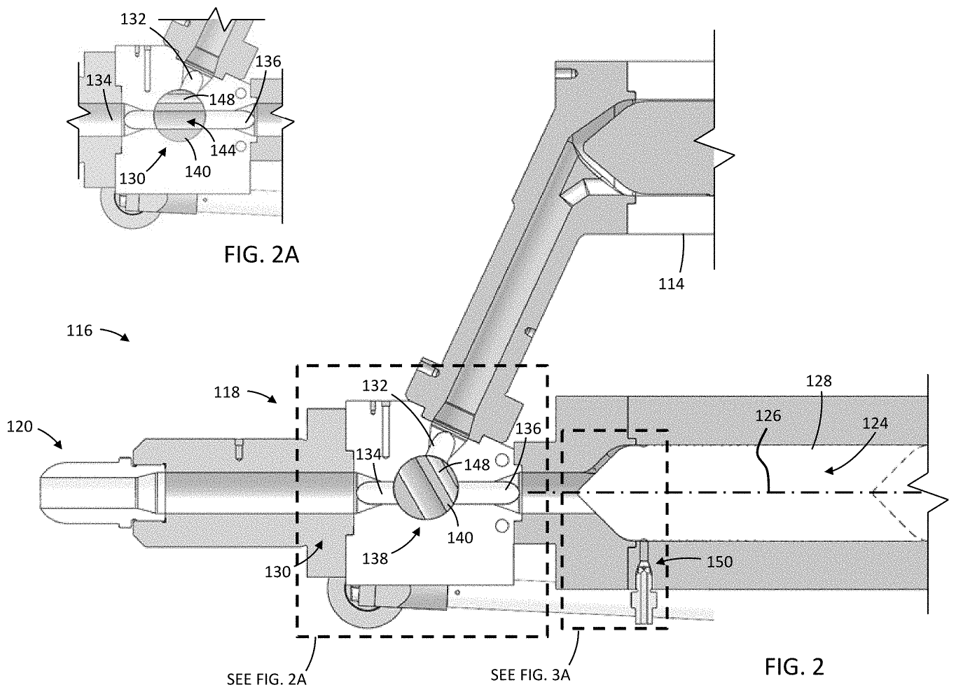

Referring to FIG. 2, in the example illustrated, the shooting pot assembly 116 includes a housing 118 having a nozzle 120 at a front end of the housing 118 for engagement with a mold sprue bushing. A plunger chamber 124 is in the housing 118 axially rearward of the nozzle 120, and extends along a chamber axis 126. The shooting pot assembly 116 includes an injection plunger 128 in the plunger chamber 124. The injection plunger 128 is translatable along the chamber axis 126 between an advanced position (shown in solid lines in FIG. 2) and a retracted position (shown schematically in dashed lines in FIG. 2) spaced axially rearward of the advanced position. In the example illustrated, the injection plunger 128 is translatable toward the retracted position to accommodate receipt of melt in the plunger chamber 124 from the plasticizing barrel 114. The plunger 128 is translatable from the retracted position toward the advanced position for discharging melt from the plunger chamber 124 through the nozzle 120.

In the example illustrated, the shooting pot assembly 116 further includes a conduit network 130 in the housing 118. The conduit network 130 includes a feed conduit 132 for receiving melt from the plasticizing barrel 114, an outlet conduit 134 for conducting melt to the nozzle 120, and a transfer conduit 136 open to the plunger chamber 124. The transfer conduit 136 is for selectively providing fluid communication between the feed conduit 132 and the plunger chamber 124 to conduct melt from the plasticizing barrel 114 to the plunger chamber 124, and between the plunger chamber 124 and the outlet conduit 134 to conduct melt from the plunger chamber 124 to the nozzle 120.

In the example illustrated, the shooting pot assembly 116 includes a transfer valve assembly 138 in the conduit network 130 between the feed conduit 132, the outlet conduit 134, and the transfer conduit 136. The transfer valve assembly 138 includes a transfer valve closure member 140 movable between a feed position (shown in FIG. 2) and an injection position (shown in FIG. 2A). Referring to FIG. 2, when the transfer valve closure member 140 is in the feed position, the transfer conduit 136 is in fluid isolation of the outlet conduit 134 and in fluid communication with the feed conduit 132 for conducting melt from the plasticizing barrel 114 to the plunger chamber 124. Referring to FIG. 2A, when the transfer valve closure member 140 is in the injection position, the transfer conduit 136 is in fluid isolation of the feed conduit 132 and in fluid communication with the outlet conduit 134 for conducting melt from the plunger chamber 124 to the nozzle 120.

The transfer valve assembly 138 can be similar to that specified in U.S. Pat. No. 9,090,011 (Schad et al.). Still referring to FIG. 2A, in the example shown, the valve closure member 140 comprises a rotary spool mounted in a valve seat. The rotary spool is rotatable within the valve seat for moving the transfer valve closure member 140 between the feed and injection positions. In the example illustrated, the rotary spool includes a transverse bore 144 extending therethrough, and a cylindrical outer surface having a notch 148 formed therein. When the transfer valve closure member 140 is in the injection position, the transfer conduit 136 and the outlet conduit 134 are in fluid communication via the transverse bore 144. Referring to FIG. 2, when the transfer valve closure member 140 is in the feed position, the feed conduit 132 and the transfer conduit 136 are in fluid communication via the notch 148.

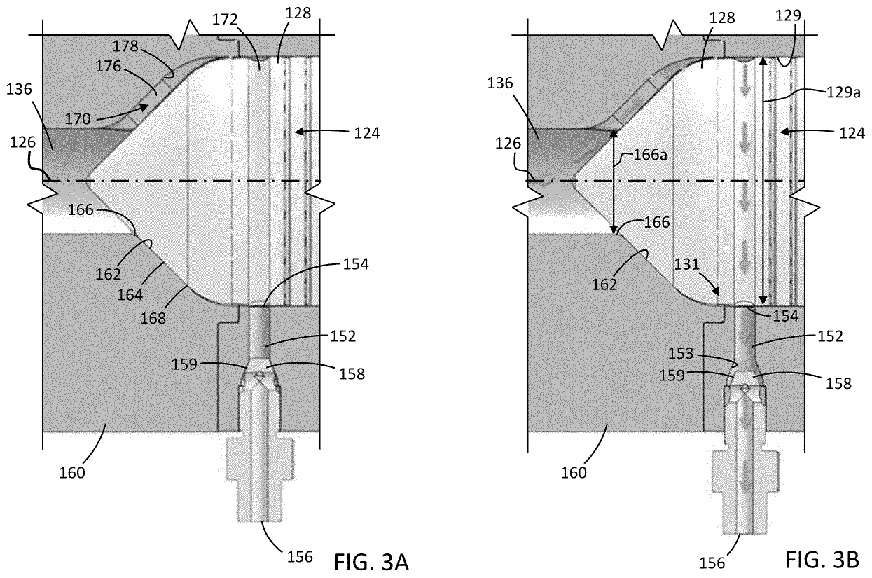

In the example illustrated, the shooting pot assembly 116 further includes a purge valve assembly 150 in the housing 118. The purge valve assembly 116 can, for example, facilitate changing the type and/or color of melt being processed by the injection unit 110 when changing between molded article production runs. Referring to FIG. 3A, in the example illustrated, the purge valve assembly 150 includes a purge conduit 152 extending between an inlet 154 and an outlet 156 opposite the inlet 154. The inlet 154 is open to the plunger chamber 124 and in fluid communication with the transfer conduit 136 through the plunger chamber 124 when the plunger 128 is in the advanced position. The purge valve assembly 150 further includes a purge valve closure member 158 in the purge conduit 152. The purge valve closure member 158 is movable between a closed position (FIG. 3A) and an open position (FIG. 3B).

Referring to FIG. 3A, when the purge valve closure member 158 is in the closed position, the purge conduit 152 is blocked to inhibit evacuation of melt from the plunger chamber 124 through the purge conduit 152. Referring to FIG. 3B, when the purge valve closure member 158 is in the open position, the purge conduit 152 is open for flushing stale melt from the transfer conduit 136 through the purge conduit 152 via supply of fresh melt into the transfer conduit 136 from the feed conduit 132. Flushing stale melt when the plunger 128 is in the advanced position can help to, for example, reduce the volume of stale melt in the plunger chamber 128, and correspondingly reduce the required supply of fresh melt for purging the stale melt.

Referring to FIG. 3B, in the example illustrated, the purge conduit 152 has a purge conduit seal surface 153 and the purge valve closure member 158 has a complementary purge valve seal surface 159 directed toward the purge conduit seal surface 153. When the purge valve closure member 158 is in the open position, the purge valve seal surface 159 is spaced apart from the purge conduit seal surface 153 by a flow gap for providing fluid communication between the inlet 154 and outlet 156 through the purge conduit 152. When the purge valve closure member 158 is in the closed position, the purge valve seal surface 159 is in sealed engagement with the purge conduit seal surface 153 (FIG. 3B) and the flow gap is closed to block fluid communication between the inlet 154 and the outlet 156 through the purge conduit 152.

Referring to FIG. 3A, in the example illustrated, the housing 118 includes a transition head 160 at a front of the plunger chamber 124. The transition head 160 has an inner transition head surface 162 directed toward the plunger 128, and the plunger 128 has a complementary leading surface 164 directed toward the transition head surface 162. When the plunger 128 is in the advanced position, the leading surface 164 of the plunger 128 is proximate the transition head surface 162. In the example illustrated, the leading surface 164 of the plunger 128 comprises an engagement portion 168, and the engagement portion 168 abuts a portion of the transition head surface 162 when the plunger 128 is in the advanced position.

Referring to FIG. 3B, in the example illustrated, the transfer conduit 136 has a transfer conduit port 166 at a rear end of the transfer conduit 136 and facing a front end of the plunger 128. In the example illustrated, the transfer conduit port 166 is generally coaxial with the chamber axis 126 and has a first diameter 166a. In the example illustrated, the plunger chamber 124 includes a cylindrical chamber bore 129 in which the plunger 128 is slidably received. In the example illustrated, the chamber bore 129 is generally coaxial with the chamber axis 126 and has a second diameter 129a. The second diameter 129a is greater than the first diameter 166a. The transition head surface 162 is axially intermediate the transfer conduit port 166 and the chamber bore 129, and slopes radially outwardly from the transfer conduit port 166 to a front end 131 of the chamber bore 129. In the example illustrated, the inlet 154 of the purge conduit 152 is proximate the front end 131 of the chamber bore 129.

Still referring to FIG. 3B, in the example illustrated, the purge conduit 152 extends through a side wall of the housing 118 and at least a portion of the purge valve closure member 158. In the example illustrated, the outlet 156 of the purge conduit 152 is open to an outer surface of the purge valve closure member 158.

Referring to FIG. 3A, in the example illustrated, when the plunger 128 is in the advanced position, at least one flow channel 170 is provided between the transition head surface 162 and the leading surface 164 of the plunger 128. The transfer conduit 136 and the inlet 154 of the purge conduit 152 are in fluid communication via the at least one flow channel 170.

In the example illustrated, the plunger 128 includes a circumferential plunger groove 172 in a radially outer surface of the plunger 128. In the example illustrated, the plunger groove 172 is disposed axially rearward of the leading surface 164. In the example illustrated, the plunger groove 172 and the inlet 154 of the purge conduit 152 are in fluid communication when the plunger 128 is in the advanced position. In the example illustrated, the inlet 154 is in axial alignment with, and open to, the plunger groove 172 when the plunger 128 is in the advanced position.

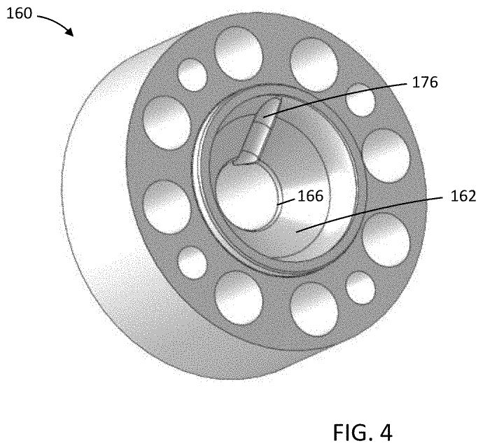

In the example illustrated, the at least one flow channel 170 includes at least one chamber groove 176 in the transition head surface 162 of the plunger chamber 124 (see also FIG. 4). The chamber groove 176 includes a groove surface 178 spaced apart from the leading surface 164 of the plunger 128. In the example illustrated, the chamber groove 176 is radially opposite of the inlet 154 of the purge conduit 152. This can help to, for example, direct flow of melt around the plunger 124 and through regions of the plunger chamber 124 that may otherwise retain stagnant melt. When the plunger 128 is in the advanced position, the chamber groove 176 extends between the transfer conduit 136 and the plunger groove 172 and provides fluid communication therebetween.

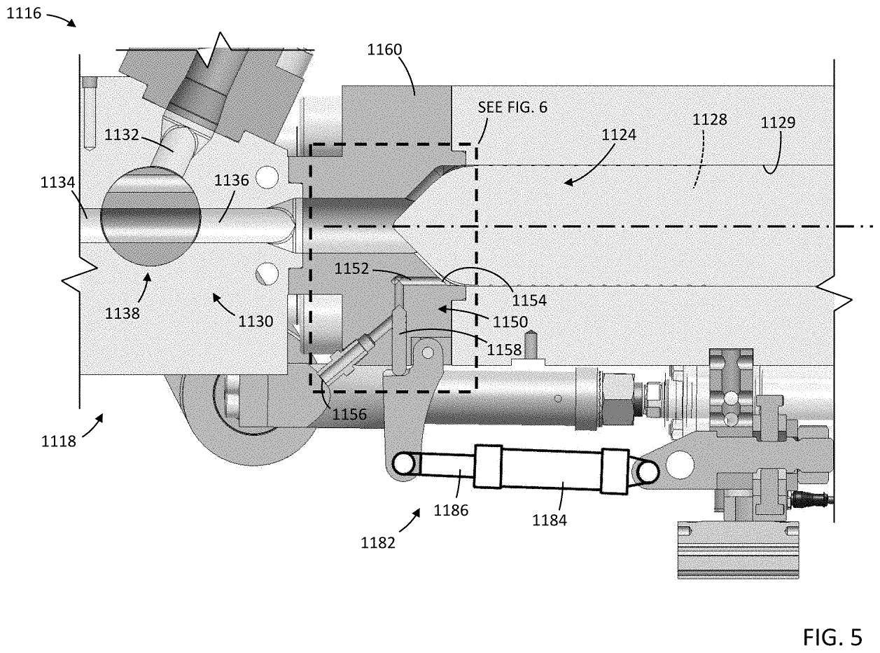

Referring to FIG. 5, a portion of another example shooing pot assembly 1116 is shown. The shooting pot assembly 1116 has similarities to the shooting pot assembly 116, and like features are identified with like reference characters, incremented by 1000.

In the example illustrated, the shooting pot assembly 1116 includes a housing 1118; a plunger chamber 1124; an injection plunger 1128; a conduit network 1130 having a feed conduit 1132, an outlet conduit 1134, and a transfer conduit 1136; a transfer valve assembly 1138; and a purge valve assembly 1150. The purge valve assembly 1150 includes a purge conduit 1152 extending between an inlet 1154 and an outlet 1156 opposite the inlet 1154, and a purge valve closure member 1158 in the purge conduit 1152 and movable between an open position and a closed position (shown in FIG. 5).

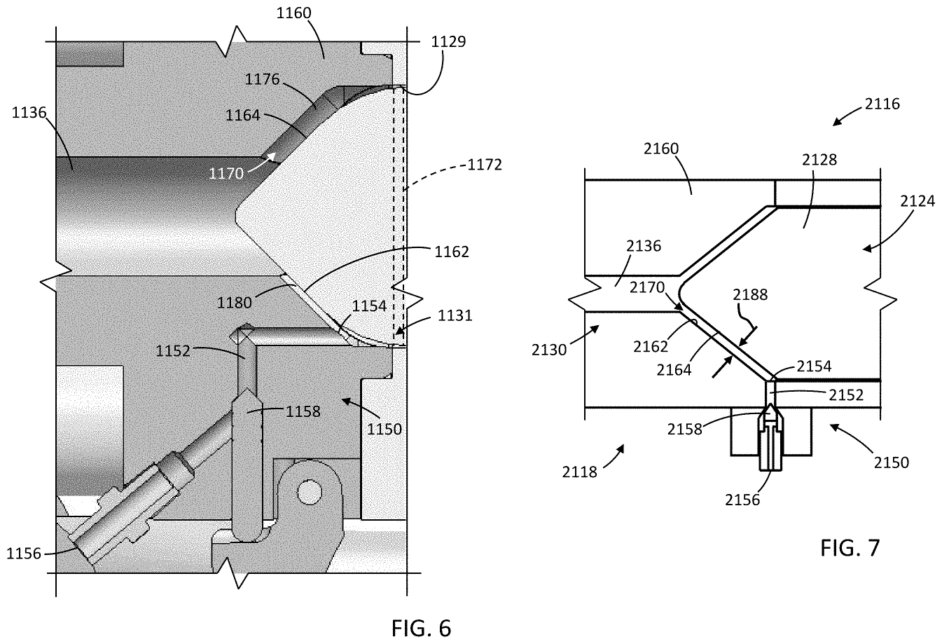

Referring to FIG. 6, in the example illustrated, the inlet 1154 of the purge conduit 1152 is proximate a front end 1131 of a plunger bore 1129 of the plunger chamber 1124. In the example illustrated, the housing 1118 includes a transition head 1160 having an inner transition head surface 1162. In the example illustrated, the plunger 1128 has a leading surface 1164 comprising an engagement portion for abutting a portion of the transition head surface 1162 when the plunger 1128 is in the advanced position.

In the example illustrated, at least one flow channel 1170 is provided between the transition head surface 1162 and the leading surface 1164 of the plunger 1128 when the plunger is in the advanced position. The transfer conduit 1136 is in fluid communication with the inlet 1154 of the purge conduit 1152 via the at least one flow channel 1170.

In the example illustrated, the plunger 1128 includes a circumferential plunger groove 1172 (shown schematically in FIG. 6) in a radially outer surface of the plunger 1128. The circumferential plunger groove 1172 is, in the example illustrated, adjacent an axially rearward portion of the leading surface 1164. The plunger groove 1172 and the inlet 1154 of the purge conduit 1152 are in fluid communication when the plunger 1128 is in the advanced position.

Referring to FIG. 6, in the example illustrated, the at least one flow channel 1170 includes at least a first chamber groove 1176 in the transition head surface 1162 of the plunger chamber 1124. In the example illustrated, the first chamber groove 1176 is radially opposite of the inlet 1154 of the purge conduit 1152. When the plunger 1128 is in the advanced position, the first chamber groove 1176 extends between the transfer conduit 1136 and the plunger groove 1172 for providing fluid communication therebetween.

In the example illustrated, the at least one flow channel 1170 further includes a second chamber groove 1180 in the transition head surface 1162. The second chamber groove 1180 extends between the transfer conduit 1136 and the inlet 1154 of the purge conduit 1152 for providing fluid communication therebetween when the plunger 1128 is in the advanced position. In the example illustrated, the first and second chamber grooves 1176, 1180 are radially opposite one another.

Referring to FIG. 5, in the example illustrated, the shooting pot assembly 1116 further includes an actuator 1182 for moving the purge valve closure member 1158 between the open and closed positions. In the example illustrated, the actuator 1182 includes a hydraulic cylinder 1184 having a piston rod 1186 movable from a first position (shown in FIG. 5) toward a second position for urging movement of the purge valve closure member 1158 from the open position toward the closed position, and from the second position toward the first position for accommodating movement of the purge valve closure member 1158 from the closed position to the open position.

Referring to FIG. 7, a portion of another example shooing pot assembly 2116 is shown. The shooting pot assembly 2116 has similarities to the shooting pot assembly 116, and like features are identified with like reference characters, incremented by 2000.

In the example illustrated, the shooting pot assembly 2116 includes a housing 2118; a plunger chamber 2124; an injection plunger 2128; a conduit network 2130 having a feed conduit, an outlet conduit, and a transfer conduit 2136; a transfer valve assembly; and a purge valve assembly 2150 including a purge conduit 2152 extending between an inlet 2154 and an outlet 2156 and a purge valve closure member 2158 in the purge conduit 2152. In the example illustrated, the housing 2118 includes a transition head 2160 having an inner transition head surface 2162 directed toward the plunger 2128, and the plunger 2128 has a complementary leading surface 2164 directed toward the transition head surface 2162.

In the example illustrated, when the plunger 2128 is in the advanced position (shown in FIG. 7), at least one flow channel 2170 is provided between the inner transition head surface 2162 and the leading surface 2164 of the plunger 2128. The transfer conduit 2136 is in fluid communication with the inlet 2154 via the at least one flow channel 2170. In the example illustrated, when the plunger 2128 is in the advanced position, the leading surface 2164 of the plunger 2128 is spaced apart from the transition head surface 2162 by a gap 2188, and the at least one flow channel 2170 comprises the gap 2188.

We claim:

1. A shooting pot assembly for a two-stage injection unit, comprising:
a) a housing;
b) a plunger chamber in the housing;
c) an injection plunger in the plunger chamber;
d) a conduit network for feeding melt into, and evacuating melt from, the plunger chamber, the conduit network including a feed conduit, an outlet conduit, and a transfer conduit; and
e) a purge valve assembly having a purge conduit open to the plunger chamber and in fluid communication with the transfer conduit through the plunger chamber when the plunger is in the advanced position, the purge valve further including a purge valve closure member movable between a closed position, in which the purge conduit is blocked, and an open position, in which the purge conduit is open for flushing stale melt from the transfer conduit through the purge conduit via supply of fresh melt into the transfer conduit from the feed conduit.

2. The shooting pot assembly of claim 1, wherein the housing includes a transition head at a front of the plunger chamber, the transition head having an inner transition head surface directed toward the plunger and the plunger having a complementary leading surface directed toward the transition head surface, and when the plunger is in the advanced position, the leading surface of the plunger is proximate the transition head surface and at least one flow channel is provided between the transition head surface and the leading surface of the plunger, wherein the transition conduit is in fluid communication with an inlet of the purge conduit via the at least one flow channel.

3. The shooting pot assembly of claim 2, wherein the plunger further comprises a circumferential plunger groove in a radially outer surface of the plunger, the plunger groove and the inlet of the purge conduit in fluid communication when the plunger is in the advanced position.

4. The shooting pot assembly of claim 3, wherein the at least one flow channel includes a first chamber groove in the transition head surface of the plunger chamber, the first chamber groove radially opposite the inlet of the purge conduit and when the plunger is in the advanced position, the first chamber groove extending between the transfer conduit and the plunger groove for providing fluid communication therebetween.

5. The shooting pot assembly of claim 4, wherein the at least one flow channel further comprises a second chamber groove in the transition head surface of the plunger chamber, the second chamber groove extending between the transfer conduit and the inlet of the purge conduit for providing fluid communication therebetween when the plunger is in the advanced position.

6. The shooting pot assembly of claim 2, wherein the leading surface of the plunger comprises an engagement portion, the engagement portion abutting a portion of the transition head surface when the plunger is in the advanced position.

7. The shooting pot assembly of claim 2, wherein when the plunger is in the advanced position the leading surface of the plunger is spaced apart from the transition head surface by a gap, and the at least one flow channel comprises the gap.

8. The shooting pot assembly of claim 1, wherein the purge valve closure member is biased to the closed position.

9. The shooting pot assembly of claim 1, further comprising an actuator for moving the purge valve closure member from the closed position to the open position.

10. The shooting pot assembly of claim 1, further comprising a transfer valve assembly in the conduit network between the feed conduit, the outlet conduit, and the transfer conduit, the transfer valve assembly including a transfer valve closure member movable between a feed position in which the transfer conduit is in fluid isolation of the outlet conduit and in fluid communication with the feed conduit for conducting melt from the plasticizing barrel to the plunger chamber, and an injection position in which the transfer conduit is in fluid isolation of the feed conduit and in fluid communication with the outlet conduit for conducting melt from the plunger chamber to the nozzle.

11. A shooting pot assembly for a two-stage injection unit, comprising:
a) a housing having a nozzle at a front end of the housing for engagement with a mold sprue bushing;
b) a plunger chamber in the housing axially rearward of the nozzle, the plunger chamber extending along a chamber axis;
c) an injection plunger in the plunger chamber, the injection plunger translatable along the chamber axis between advanced and retracted positions;
d) a conduit network in the housing, the conduit network including:
i) a feed conduit for receiving melt from a plasticizing barrel,
ii) an outlet conduit for conducting melt to the nozzle, and
iii) a transfer conduit open to the plunger chamber, the transfer conduit for selectively providing fluid communication between the feed conduit and the plunger chamber to conduct melt from the plasticizing barrel to the plunger chamber, and between the plunger chamber and the outlet conduit to conduct melt from the plunger chamber to the nozzle; and
e) a purge valve assembly in the housing, the purge valve assembly including a purge conduit extending between an inlet and an outlet opposite the inlet, the inlet open to the plunger chamber and in fluid communication with the transfer conduit through the plunger chamber when the plunger is in the advanced position, the purge valve assembly further including a purge valve closure member in the purge conduit, the purge valve closure member movable between a closed position and an open position, wherein when the purge valve closure member is in the closed position, the purge conduit is blocked to inhibit evacuation of melt from the plunger chamber through the purge conduit, and when the purge valve closure member is in the open position, the purge conduit is open for flushing stale melt from the transfer conduit through the purge conduit via supply of fresh melt into the transfer conduit from the feed conduit.

12. The shooting pot assembly of claim 11, wherein the housing includes a transition head at a front of the plunger chamber, the transition head having an inner transition head surface directed toward the plunger and the plunger having a complementary leading surface directed toward the transition head surface, and when the plunger is in the advanced position, the leading surface of the plunger is proximate the transition head surface and at least one flow channel is provided between the transition head surface and the leading surface of the plunger, wherein the transition conduit is in fluid communication with the inlet of the purge conduit via the at least one flow channel.

13. The shooting pot assembly of claim 12, wherein the plunger further comprises a circumferential plunger groove in a radially outer surface of the plunger, the plunger groove and the inlet of the purge conduit in fluid communication when the plunger is in the advanced position.

14. The shooting pot assembly of claim 13, wherein the at least one flow channel includes a first chamber groove in the transition head surface of the plunger chamber, the first chamber groove radially opposite the inlet of the purge conduit and when the plunger is in the advanced position, the first chamber groove extending between the transfer conduit and the plunger groove for providing fluid communication therebetween.

15. The shooting pot assembly of claim 14, wherein the at least one flow channel further comprises a second chamber groove in the transition head surface of the plunger chamber, the second chamber groove extending between the transfer conduit and the inlet of the purge conduit for providing fluid communication therebetween when the plunger is in the advanced position.

16. The shooting pot assembly of claim 12, wherein the leading surface of the plunger comprises an engagement portion, the engagement portion abutting a portion of the transition head surface when the plunger is in the advanced position.

17. The shooting pot assembly of claim 12, wherein when the plunger is in the advanced position the leading surface of the plunger is spaced apart from the transition head surface by a gap, and the at least one flow channel comprises the gap.

18. The shooting pot assembly of claim 11, wherein the purge valve closure member is biased to the closed position.

19. The shooting pot assembly of claim 11, further comprising an actuator for moving the purge valve closure member from the closed position to the open position.

20. The shooting pot assembly of claim 11, further comprising a transfer valve assembly in the conduit network between the feed conduit, the outlet conduit, and the transfer conduit, the transfer valve assembly including a transfer valve closure member movable between a feed position in which the transfer conduit is in fluid isolation of the outlet conduit and in fluid communication with the feed conduit for conducting melt from the plasticizing barrel to the plunger chamber, and an injection position in which the transfer conduit is in fluid isolation of the feed conduit and in fluid communication with the outlet conduit for conducting melt from the plunger chamber to the nozzle.
